(19) United States
(12) Patent Application Publication
(10) Pub. No.: US 2021/0056389 A1
(43) Pub. Date: Feb. 25, 2021

(54) NEURAL NETWORK COMPUTING METHOD AND SYSTEM INCLUDING THE SAME

(71) Applicant: SAMSUNG ELECTRONICS CO., LTD., SUWON-SI (KR)

(72) Inventor: SEUNG-SOO YANG, HWASEONG-SI (KR)

(21) Appl. No.: 16/860,830

(22) Filed: Apr. 28, 2020

(30) Foreign Application Priority Data
Aug. 23, 2019 (KR) 10-2019-0103543

(51) Int. Cl. G06N 3/04; G06N 3/063; G06F 16/901

(52) U.S. Cl. CPC G06N 3/0454; G06F 16/9024; G06N 3/063

(57) ABSTRACT

A neural network computing system includes a processor, and a deep learning framework under control of the processor. The framework obtains model information of a neural network model by reading at least one neural network model file, creates a neural network graph of the neural network model using the model information, adjusts the neural network graph such that the neural network model corresponds to an operation of a first hardware computing device and an operation of a second hardware computing device, divides the neural network model into a plurality of sub-models, including first and second sub-models, pipelines the first and second hardware computing devices by allocating the first and second sub-models to the first and second hardware computing devices, respectively, and detects a reduced hardware latency measurement from among a plurality of hardware latency measurements obtained by changing at least one of hardware latencies of the first and second sub-models.

### CROSS-REFERENCE TO RELATED APPLICATIONS

This application claims priority under 35 U.S.C. § 119 to Korean Patent Application No. 10-2019-0103543, filed on Aug. 23, 2019, the disclosure of which is incorporated by reference herein in its entirety.

### TECHNICAL FIELD

The present disclosure relates to a neural network computing method and a system including the same.

### DISCUSSION OF THE RELATED ART

An artificial neural network (ANN) is a computational model implemented as software or hardware that mimics the computational power of a biological system using a considerable number of artificial neurons connected by connecting lines. In the ANN, artificial neurons that simplify the functions of biological neurons are used. The artificial neurons are interconnected by connecting lines with connecting strength to perform human cognitive actions or learning processes. Recently, ANN-based deep learning has been studied, and research has been conducted into various ways to improve the processing performance of the ANN in connection with deep learning.

To implement deep learning inference, hardware accelerators may be used. Due to computational constraints, dedicated hardware may use heterogenous accelerators as a heterogenous system.

### SUMMARY

Exemplary embodiments of the present disclosure provide a neural network (NN) computing system that increases processing speed by eliminating stalls during parallel processing using pipelining between heterogenous hardware accelerators.

Exemplary embodiments of the present disclosure also provide a NN computing method that increases processing speed by eliminating stalls during parallel processing using pipelining between heterogenous hardware accelerators.

Exemplary embodiments of the present disclosure also provide a computing system that increases processing speed by eliminating stalls during parallel processing using pipelining between heterogenous hardware accelerators.

According to an exemplary embodiment, a neural network computing system includes a processor and a deep learning framework under control of the processor. The deep learning framework is configured to obtain model information of a neural network model by reading at least one neural network model file, create a neural network graph of the neural network model using the model information, and adjust the neural network graph such that the neural network model corresponds to an operation of a first hardware computing device and an operation of a second hardware computing device, which is different from the operation of the first hardware computing device. The deep learning framework is further configured to divide the neural network model into a plurality of sub-models, including first and second sub-models, pipeline the first and second hardware computing devices by allocating the first and second sub-models to the first and second hardware computing devices, respectively, and detect a reduced hardware latency measurement from among a plurality of hardware latency measurements obtained by changing at least one of hardware latencies of the first and second sub-models.

According to an exemplary embodiment, a neural network computing method includes obtaining model information of a neural network model by reading at least one neural network model file, creating a neural network graph of the neural network model using the model information, dividing the neural network model into a plurality of sub-models, including first and second sub-models, and pipelining the first and second hardware computing devices by allocating the first and second sub-models to the first and second hardware computing devices, respectively. The second hardware computing device performs a different operation from the first hardware computing device. The method further includes compiling the first and second sub-models into the first and second hardware computing devices, respectively.

According to an exemplary embodiment, a computer system includes a processor controlling a total operation of the computer system, a memory storing data for controlling the computer system, a deep learning framework controlled by the processor, and a plurality of hardware computing devices controlled by the deep learning framework. The deep learning framework is configured to obtain model information of a neural network model by reading at least one neural network model file, create a neural network graph of the neural network model using the model information, and adjust the neural network graph such that the neural network model corresponds to an operation of a first hardware computing device and an operation of a second hardware computing device, which is different from the operation of the first hardware computing device. The deep learning framework is further configured to divide the neural network model into a plurality of sub-models, including first and second sub-models, pipeline the first and second hardware computing devices by allocating the first and second sub-models to the first and second hardware computing devices, respectively, and detect a reduced hardware latency measurement from among a plurality of hardware latency measurements obtained by changing at least one of hardware latencies of the first and second sub-models.

### BRIEF DESCRIPTION OF THE DRAWINGS

The above and other features of the present disclosure will become more apparent by describing in detail exemplary embodiments thereof with reference to the accompanying drawings, in which:

FIG. 1 is a block diagram of a computer system according to exemplary embodiments of the present disclosure.

FIG. 2 is a block diagram of a neural network (NN) computing system according to exemplary embodiments of the present disclosure.

FIG. 3 is a block diagram of a runtime compiler of FIG. 2 according to exemplary embodiments of the present disclosure.

FIG. 4 is a block diagram illustrating an operation of a NN computing system according to exemplary embodiments of the present disclosure.

FIG. 5 is a schematic view illustrating a NN graph of FIG. 4 according to exemplary embodiments of the present disclosure.

FIG. 6 is a schematic view illustrating NN sub-graphs of FIG. 4 according to exemplary embodiments of the present disclosure.

FIG. 7 is a timing diagram illustrating pipelining according to the exemplary embodiment of FIG. 6.

FIG. 8 illustrates a NN computing method according to exemplary embodiments of the present disclosure.

FIG. 9 illustrates a NN computing method according to exemplary embodiments of the present disclosure.

FIG. 10 is a block diagram illustrating a NN computing method according to exemplary embodiments of the present disclosure.

FIG. 11 is a block diagram illustrating a NN computing method according to exemplary embodiments of the present disclosure.

FIG. 12 is a block diagram illustrating a NN computing method according to exemplary embodiments of the present disclosure.

FIG. 13 is a timing diagram illustrating the benefits of the NN computing method according to the exemplary embodiment of FIG. 8.

FIG. 14 is a timing diagram illustrating the benefits of the NN computing method according to the exemplary embodiment of FIG. 9.

### DETAILED DESCRIPTION

Exemplary embodiments of the present disclosure will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

It should be understood that descriptions of features or aspects within each exemplary embodiment should typically be considered as available for other similar features or aspects in other exemplary embodiments, unless the context clearly indicates otherwise.

As used herein, the singular forms “a”, “an” and “the” are intended to include the plural forms as well, unless the context clearly indicates otherwise.

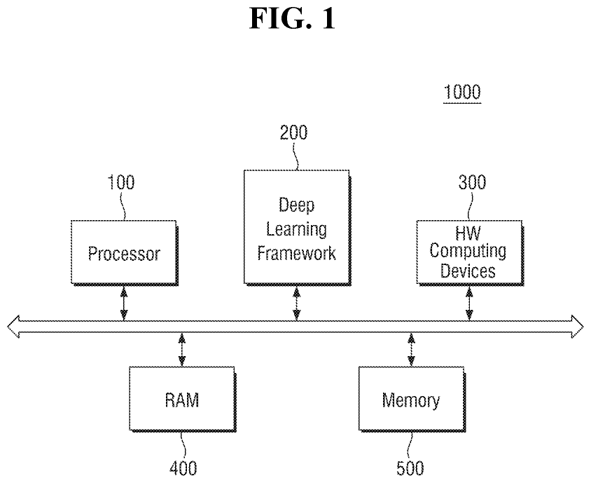

FIG. 1 is a block diagram of a computer system 1000 according to exemplary embodiments of the present disclosure.

The computer system 1000 may analyze input data in real time based on a neural network (NN) to extract valid information, and may determine the circumstances or control the elements of an electronic device mounted thereon based on the extracted information.

The computer system 1000 may be, for example, an application processor (AP), which may be employed in a mobile device. Alternatively, the computer system 1000 may be, for example, a robotic device such as a drone or an advanced drivers assistance system (ADAS), a smart television (TV), a smartphone, a medical device, a mobile device, a display device, a measuring device, or an Internet-of-Things (IoT) device. However, the computer system 1000 is not limited thereto. The computer system 1000 will hereinafter be described as being, for example, an AP.

Referring to FIG. 1, the computer system 1000 may include a processor 100, a deep learning framework 200, hardware computing devices 300, a random-access memory (RAM) 400, and a memory 500. At least some of these elements of the computer system 1000 may be mounted on a single semiconductor chip.

The computer system 1000 may perform neural network (NN) computing functions, and may thus be defined as including a neural network system (NNS). The NNS may include at least some of the elements of the computer system 1000, which may be used in connection with a NN operation. Referring to FIG. 1, the NNS may include the processor 100, the deep learning framework 200, and the hardware computing devices 300. However, the present disclosure is not limited thereto. For example, various elements associated with the NN operation other than those illustrated in FIG. 1 may be included in the NNS.

The processor 100 controls the general operation of the computer system 1000. The processor 100 may include a single processor core or multiple processor cores. The processor 100 may process or execute programs and/or data stored in the memory 500. The processor 100 may control the deep learning framework 200 and the hardware computing devices 300 by executing programs stored in the memory 500.

The RAM 400 may temporarily store programs, data, or instructions. For example, the programs and/or the data stored in the memory 500 may be temporarily stored in the RAM 400 in accordance with control or boot code of the processor 100. The RAM 400 may be implemented as a memory such as, for example, a dynamic RAM (DRAM) or a static RAM (SRAM).

The memory 500 may store control instruction code, control data, or user data for controlling the computer system 1000. The memory 500 may include at least one of a volatile memory and a nonvolatile memory. For example, the memory 500 may be implemented as a DRAM, an SRAM, or an embedded DRAM.

The deep learning framework 200 may perform NN-based tasks based on various types of NNs. Operations required by NNs may be executed by the hardware computing devices 300.

Examples of the NNs include various types of NNs such as a convolution neural network (CNN) such as GoogLeNet, AlexNet, or VGG Network, a region-CNN (R-CNN), a region proposal network (RPN), a recurrent neural network (RNN), a stacking-based deep neural network (S-DNN), a state-space dynamic neural network (S-SDNN), a deconvolution network, a deep belief network (DBN), restricted Boltzmann machine (RBM), a fully convolutional network, a long short-term memory (LSTM) network, and a classification network. However, the present disclosure is not limited thereto.

A NN that performs a single task may include sub-NNs, and the sub-NNs may be implemented as heterogenous sub-models and may be operated by heterogenous hardware computing devices 300.

The computer system 1000 may execute various types of applications, and the applications may send a request to the deep learning framework 200 for homogenous or heterogenous hardware computing devices 300 to perform operations. The deep learning framework 200 may allow heterogeneous hardware computing devices 300 to operate in a non-blocking mode so that the heterogeneous hardware computing devices 300 can simultaneously perform their operations in parallel, i.e., the heterogenous hardware computing devices 300 can be pipelined. Even in the non-blocking mode, the deep learning framework 200 may change the hardware latencies of the hardware computing devices 300 to improve hardware utilization and to reduce a total hardware latency.

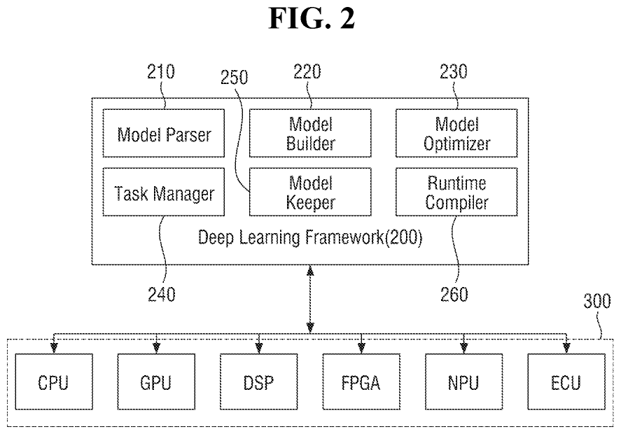

FIG. 2 is a block diagram of a NN computing system according to exemplary embodiments of the present disclosure.

Referring to FIG. 2, the deep learning framework 200 may include a model parser 210, a model builder 220, a model optimizer 230, a task manager 240, a model keeper 250, and a runtime compiler 260.

The deep learning framework 200, including each of the model parser 210, the model builder 220, the model optimizer 230, the task manager 240, the model keeper 250, and the runtime compiler 260, may be implemented as software, hardware, firmware, or a combination thereof. For example, when these components are implemented as hardware, the components may be embodied by application specific integrated circuits (ASICs), digital signal processors (DSPs), digital signal processor devices (DSPDs), programmable logic devices (PLDs), field programmable gate arrays (FPGAs), processors including general-purpose processors, controllers, micro-controllers, microprocessors, electronic devices, other electronic units designed to perform functions described in the present disclosure, or combinations thereof.

The deep learning framework 200 may control the hardware computing devices 300. FIG. 2 illustrates that the hardware computing devices 300 include a central processing unit (CPU), a graphics processing unit (GPU), a digital signal processor (DSP), a field programmable gate array (FPGA), a neural process unit (NPU), and an electronic control unit (ECU). However, the present disclosure is not limited thereto. In addition, the hardware computing devices 300 may further include hardware accelerators that can perform hardware operations.

The model parser 210 may read input NN model files to obtain model information of an input NN model, and may parse various information from the input NN model.

For example, the model parser 210 may parse various information. The various information may include, for example, layer topology such as depth and branch, information regarding a compression method, information regarding an operation type in each layer, data property information such as format, security, and size, memory layout information for an operand such as input, kernel/filter, and output, and information regarding a data compression method. The kernel/filter may correspond to a weight, and the memory layout information may include padding, stride, etc.

The model builder 220 may create a NN graph of the input NN model using the model information acquired by the model parser 210. A NN model may include, for example, an input layer, hidden layers, and an output layer, and each of these layers may include one or more neurons. The model builder 220 may create the NN graph using the layers of the NN model and the neurons of each of the layers of the NN model in accordance with the information parsed by the model parser 210.

The model optimizer 230 may adjust the NN model for which the NN graph has been created by adjusting the NN graph. Since the type of operation required for each hidden layer of each of multiple sub-models included in the NN model may vary, the type of operation required for each of the sub-models may also vary. Accordingly, the sub-models can be operated by heterogenous hardware computing devices 300 that perform different operations. The model optimizer 230 may replace, merge, or divide and adjust hardware operations so that the sub-models can correspond to the hardware computing devices 300. For example, the model optimizer 230 may adjust the NN graph such that the NN model corresponds to an operation of a first hardware computing device 300, an operation of a second hardware computing device 300 which is different from the operation of the first hardware computing device 300, an operation of a third hardware computing device 300 which is different from the operations of the first and second hardware computing devices 300, etc. As a result, the hardware latencies of the hardware computing devices 300 can be changed. Accordingly, the total hardware latency for the entire NN model can be measured, and a minimum total hardware latency measurement can be determined and implemented.

Although exemplary embodiments are described herein as determining a minimum total hardware latency measurement, the present disclosure is not limited thereto. For example, in exemplary embodiments, a reduced total hardware latency measurement at least slightly greater than the minimum total hardware latency measurement may be determined. Thus, when reference is made herein to a minimum total hardware latency measurement, that measurement may instead be a reduced total hardware latency measurement according to exemplary embodiments.

The task manager 240 may divide the NN model into a plurality of sub-models and may pipeline the hardware computing devices 300 by allocating the sub-models to the hardware computing devices 300.

Also, the task manager 240 may pipeline the hardware computing devices 300 by measuring the total hardware latency and determining the minimum total hardware latency measurement.

The task manager 240 may analyze hardware capabilities and the preferences/policies/runtime context of a host or processor (or all considerations of the task manager 240), and may pipeline the hardware computing devices 300 by measuring the total hardware latency, while adjusting the hardware latencies of the hardware computing devices 300 and determining the minimum total hardware latency measurement. For example, the hardware latencies of the hardware computing devices 300 may be changed, and the effect this has on the total hardware latency may be observed, thus allowing for the detection of a minimum hardware latency measurement from among a plurality of hardware latency measurements. Once the minimum total hardware latency measurement is determined, the hardware latencies of the hardware computing devices 300 may be adjusted to the values that caused the determined minimum total hardware latency measurement. Thus, exemplary embodiments may utilize a NN to reduce overall latency and improve operation of a computing system.

The adjustment of the hardware latencies of the hardware computing devices 300 (e.g., by way of adjusting the hardware latencies of the corresponding sub-models) may include, for example, delegating a sub-model allocated to a hardware computing device 300 with a longest hardware latency to another hardware computing device 300, merging, dividing, or replacing and modifying operations of the hardware computing devices 300, changing the hardware capabilities of the hardware computing devices 300, and changing the performances of the hardware computing devices 300, such as the outputs, frequencies, and modes of the hardware computing devices 300.

The task manager 240 not only adjusts the hardware latencies of the hardware computing devices 300, but also adjusts and measures the total hardware latency while adjusting the relationships between heterogenous hardware computing devices 300, and pipelines the hardware computing devices 300 by determining the minimum total hardware latency measurement. Also, the task manager 240 may pipeline the hardware computing devices 300 by determining the minimum total hardware latency measurement in a particular method prescribed in the NN model file. For example, the task manager 240 may pipeline the hardware computing devices 300 based on parameters defined in each of the NN model files.

The adjustment of the relationships between heterogenous hardware computing devices 300 may involve, for example, changing available hardware computing devices 300 in accordance with a dynamic hardware schedule, changing an operation path between the hardware computing devices 300, and adding/modifying pre- or post-processing by changing the operation path.

The addition/modification of pre- and post-processing may involve, in a case in which a DSP is included in the operation path, performing quantization before or after an operation of the DSP, and in a case in which a GPU is included in the operation path, adding a data layout and adding an input/weight rearrangement for each of the hardware computing devices 300, before an operation of the GPU.

The model keeper 250 may temporarily store model information of sub-models that have been compiled into the hardware computing devices 300 by the runtime compiler 260 or have been precompiled.

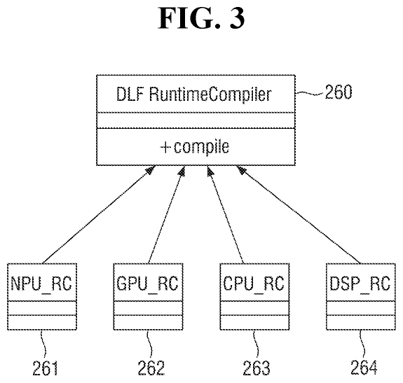

FIG. 3 is a block diagram of the runtime compiler 260 of FIG. 2 according to exemplary embodiments of the present disclosure.

Referring to FIGS. 2 and 3, the runtime compiler 260 is included in the deep learning framework 200. In addition, compilers 261 through 264 dedicated to the hardware computing devices 300 may be provided. Although FIG. 3 illustrates only the compilers for an NPU, a GPU, a CPU, and a DSP, the present disclosure is not limited thereto, and compilers for other hardware computing devices 300 may be further provided.

The runtime compiler 260 may perform compilation during runtime and may compile sub-models allocated to the hardware computing devices 300 into the hardware computing devices 300.

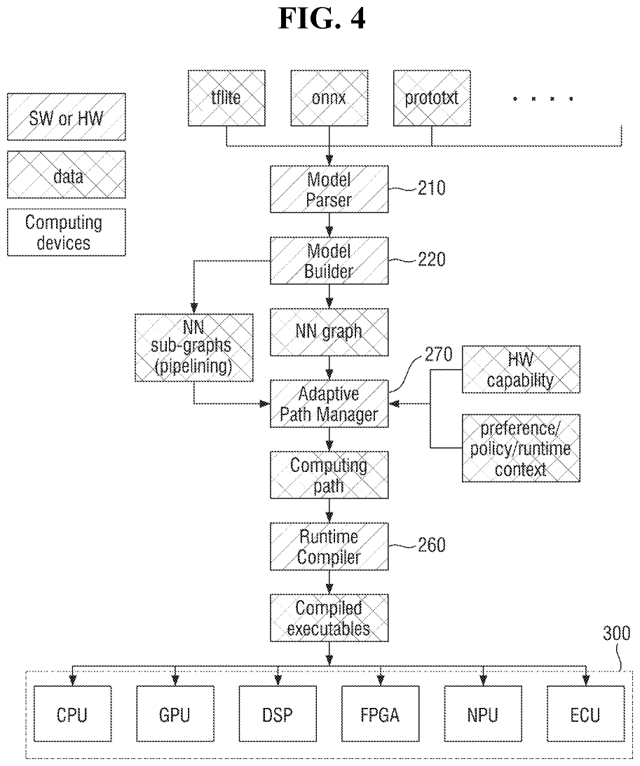

FIG. 4 is a block diagram illustrating an operation of a NN computing system according to exemplary embodiments of the present disclosure.

Referring to FIG. 4, NN model files may be input to the model parser 210. The input NN model files may be in the formats of, for example, tflite, onnx, and prototxt. However, the present disclosure is not limited thereto, and the input NN model files may also include NN model files of other formats than those set forth herein.

The model parser 210 may read the input NN model files and may obtain and parse model information of a NN model. The model parser 210 may transmit the obtained model information to the model builder 220 and may create a NN graph based on the obtained model information.

The NN model may include a plurality of sub-models, each having a hidden layer.

The model builder 220 may transmit the NN model to an adaptive path manager 270. The adaptive path manager 270 may include the model optimizer 230 and the task manager 240 of FIG. 2.

Accordingly, the NN model may be divided into sub-models, and the sub-models may be allocated to the hardware computing devices 300 so that the hardware computing devices 300 can be pipelined. Then, a total hardware latency may be measured while adjusting the hardware latencies of the hardware computing devices 300, and a minimum total hardware latency measurement may be found. Alternatively, the pipelining of the hardware computing devices 300 may be performed by determining the minimum total hardware latency measurement in a particular method prescribed in each of the input NN model files.

The sub-models may be allocated to the hardware computing devices 300 to correspond to the minimum total hardware latency measurement, and the runtime compiler 260 may compile the sub-models into the hardware computing devices 300.

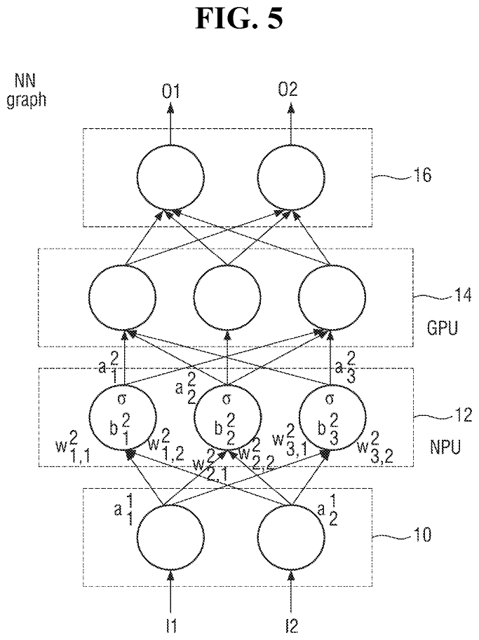

FIG. 5 is a schematic view illustrating a NN graph of FIG. 4 according to exemplary embodiments of the present disclosure.

Referring to FIGS. 4 and 5, the model builder 220 may transmit a NN graph to the adaptive path manager 270.

A NN may include an input layer, hidden layers, and an output layer. The NN may perform operations based on input data (e.g., I1 and I2) and may generate output data (e.g., O1 and O2) based on the results of the operations.

The NN may be a deep neural network (DNN) including two or more hidden layers or an n-layer NN. For example, as shown in FIG. 5, the NN may be a DNN including an input layer 10, first and second hidden layers 12 and 14, and an output layer 16.

In a case in which the NN is a DNN, the NN can process complicated data sets because it includes many layers from which to extract valid information. In FIG. 5, the NN is illustrated as including four layers. However, the present disclosure is not limited thereto. For example, the number of layers included in the NN may vary.

Each of the layers of the NN may include a plurality of neurons. The neurons may correspond to, for example, processing elements (PE), units, or artificial nodes. For example, as illustrated in FIG. 5, the input layer 10 may include two neurons (or nodes), and each of the first and second hidden layers 12 and 14 may include three neurons (or nodes). The first hidden layer 12 may be operated by an NPU, and the second hidden layer 14 may be operated by a GPU. However, the present disclosure is not limited thereto. The number of neurons (or nodes) included in each of the layers of the NN may vary, the layers of the NN may perform different operations from those set forth herein, and the layers of the NN may be operated by different hardware computing devices 300 from those set forth herein.

The neurons included in each of the layers of the NN may be connected to one another and may thus exchange data with one another. A single neuron may receive data from other neurons to perform an operation and may output the result of the operation to other neurons.

Each neuron's (or node's) input and output may be referred to as input activation and output activation, respectively. For example, activation may be a parameter that corresponds not only to the output of a neuron, but also the input of neurons included in the subsequent layer.

Each neuron may determine its activation based on activations (e.g., a11 and a12, and a21 and a23), weights (e.g., w_{1,1}², w_{1,2}², w_{2,1}², w_{2,2}², w_{3,1}², and w_{3,2}²), and biases (e.g., b₁², b₂², and b₃²) received from neurons included in the previous layer.

A weight and a bias are parameters used to calculate output activation in each neuron. A weight is a value allocated to the connection between neurons, and a bias is a weight value associated with each neuron.

In order for each neuron to determine its activation, i.e., in order to determine each layer's output, the layers of the NN may include at least one operation.

The NN, which has a multilayer structure, may include a plurality of operations and may require a considerable amount of computation to process input data to generate output data.

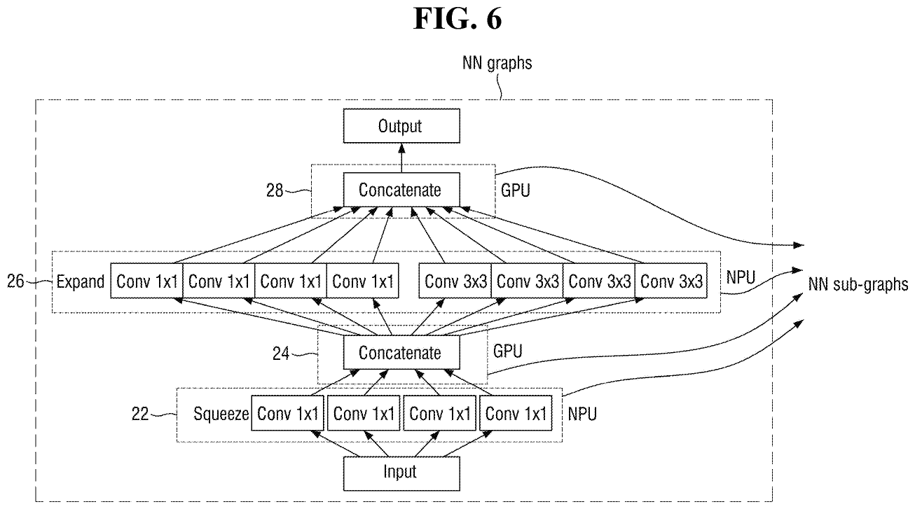

FIG. 6 is a schematic view illustrating NN sub-graphs of FIG. 4 according to exemplary embodiments of the present disclosure.

Referring to FIGS. 4 and 6, the model builder 220 may transmit a NN graph to the adaptive path manager 270.

The NN graph may include a plurality of first, second, third, and fourth hidden layers 22, 24, 26, and 28, an input layer “Input”, and an output layer “Output”.

A “Cony 1×1” operation may be performed in the first hidden layer 22 by an NPU. A “Concatenate” operation may be performed in the second hidden layer 24, which receives output activation of the first hidden layer 22, by a GPU. A “Cony 1×1” operation and a “Cony 3×3” operation may be performed in the third hidden layer 26, which receives output activation of the second hidden layer 24, by the NPU. A “Concatenate” operation may be performed in the fourth hidden layer 28, which receives output activation of the third hidden layer 26, by the GPU, and the GPU may transmit output activation of the fourth hidden layer 28 to the output layer “Output”.

A hardware computing device 300 may be allocated to each of the first, second, third, and fourth hidden layers 22, 24, 26, and 28. Since the first, second, third, and fourth hidden layers 22, 24, 26, and 28 are included in the NN graph and account for parts of the NN graph, the first, second, third, and fourth hidden layers 22, 24, 26, and 28 may be referred to as NN sub-groups or as sub-models of a NN.

The first, second, third, and fourth hidden layers 22, 24, 26, and 28 of FIG. 6 may be NN sub-graphs and may be sub-models of a NN. Accordingly, in a case in which a NN is used with heterogenous hardware accelerators, NN sub-graphs of the NN may also be used.

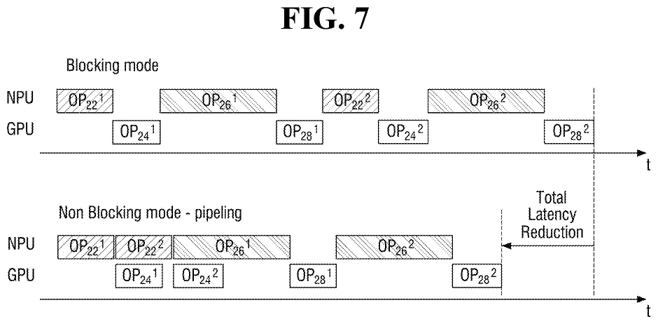

FIG. 7 is a timing diagram illustrating pipelining according to the exemplary embodiment of FIG. 6.

Referring to FIGS. 6 and 7, inference may be made from the input layer “Input” to the output layer “Output” through the first, second, third, and fourth hidden layers 22, 24, 26, and 28.

In the example of FIG. 7, two inferences are made. In the first inference, an operation OP₂₂¹ in the first hidden layer 22 may be performed by an NPU, an operation OP₂₄¹ in the second hidden layer 24 may be performed by a GPU, an operation OP₂₆¹ in the third hidden layer 26 may be performed by the NPU, and an operation OP₂₈¹ in the fourth hidden layer 28 may be performed by the GPU.

In the second inference, an operation OP₂₂² in the first hidden layer 22 may be performed by the NPU, an operation OP₂₄² in the second hidden layer 24 may be performed by the GPU, an operation OP₂₆² in the third hidden layer 26 may be performed by the NPU, and an operation OP₂₈² in the fourth hidden layer 28 may be performed by the GPU.

In a blocking mode, the operation OP₂₄¹ may begin after the processing of the operation OP₂₂¹ by the NPU. When the operation OP₂₄¹ is being performed by the GPU, the NPU does not operate. Then, the NPU begins the operation OP₂₆¹ only after the operation OP₂₄¹. In an exemplary embodiment, the GPU does not operate until the operations OP₂₄¹ and OP₂₆¹ are both finished.

In the blocking mode, an operation of one hardware computing device 300 may begin only after an operation of another hardware computing device 300. In the second inference, like in the first inference, the operation OP₂₂² of the NPU may begin only after the operation OP₂₈¹ of the GPU.

Similarly, the operation OP₂₄² may begin only after the operation OP₂₂² of the NPU. When the operation OP₂₄² is being performed by the GPU, the NPU does not operate. Then, the NPU begins the operation OP₂₆² only after the operation OP₂₄². In an exemplary embodiment, the GPU does not operate until the operations OP₂₄² and OP₂₆² are finished.

In a non-blocking mode, the first inference begins in the NPU, and after the operation OP₂₂¹ in the first inference, the operation OP₂₂² in the second inference and the operation OP₂₄¹ in the first inference may begin in the NPU and the GPU, respectively.

Accordingly, the operation OP₂₂² may be performed in the NPU readily after the operation OP₂₂¹ and the operation OP₂₈² may begin after the operation OP₂₆¹ in the NPU and then the operation OP₂₆² in the NPU.

After the operation OP₂₄¹ in the GPU and then the operation OP₂₂² in the NPU, the operation OP₂₄² may begin. Thereafter, the operation OP₂₈² may begin after the operation OP₂₆² in the NPU.

In this manner, hardware utilization in the non-blocking mode can be improved, and as a result, a total hardware latency can be reduced.

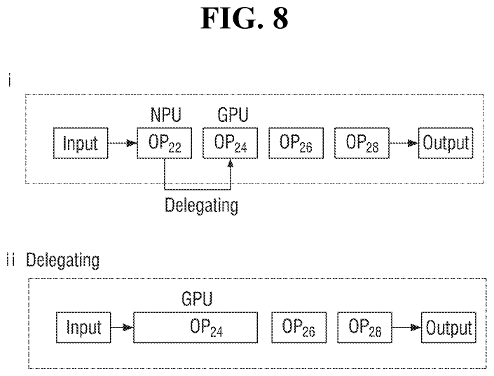

FIG. 8 illustrates a NN computing method according to exemplary embodiments of the present disclosure.

Section “i” of FIG. 8 is an operational block diagram illustrating the NN model of FIG. 6 according to exemplary embodiments. Referring to FIGS. 2, 6, and 8, the task manager 240 may change the hardware latencies of the hardware computing devices 300 by delegating part of the sub-model of a hardware computing device 300 with a longest hardware latency (e.g., a longest hardware latency relative to the other provided hardware computing devices 300) to another hardware computing device 300, for example, by delegating an operation OP₂₂ of an NPU to an operation OP₂₄ of a GPU. Accordingly, the hardware latencies of the NPU and the GPU may be changed by delegating one of operations of the NPU (e.g., the operation OP₂₄ and an operation OP₂₆) (in FIG. 8, the operation OP₂₂) to the GPU.

Referring to section “ii” of FIG. 8, the operation OP₂₄, the operation OP₂₆, and an operation OP₂₈ may be sequentially operated, following the input layer “Input”, and may then be sequentially transferred to the output layer “Output”.

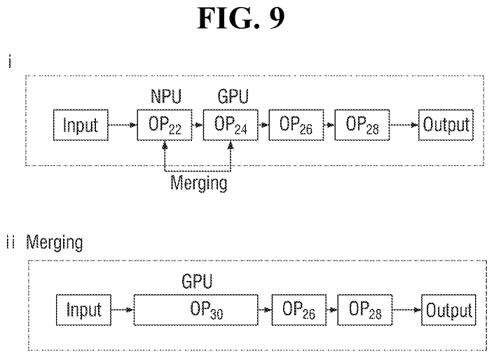

FIG. 9 illustrates a NN computing method according to exemplary embodiments of the present disclosure.

Section “i” of FIG. 9 is an operational block diagram illustrating the NN model of FIG. 6 according to exemplary embodiments. Referring to FIGS. 2, 6, and 9, the model optimizer 230 or the task manager 240 may change the hardware latencies of the hardware computing devices 300 by merging, dividing, or replacing operations of the hardware computing devices 300.

Section “ii” of FIG. 9 is an operational block diagram obtained by merging an operation OP₂₂ of an NPU and an operation OP₂₄ of a GPU into a single operation, i.e., an operation OP₃₀.

Referring to section “ii” of FIG. 9, the operation OP30, an operation OP₂₆, and an operation OP₂₈ may be sequentially operated, following an input layer “Input”, and may then be sequentially transferred to an output layer “Output”.

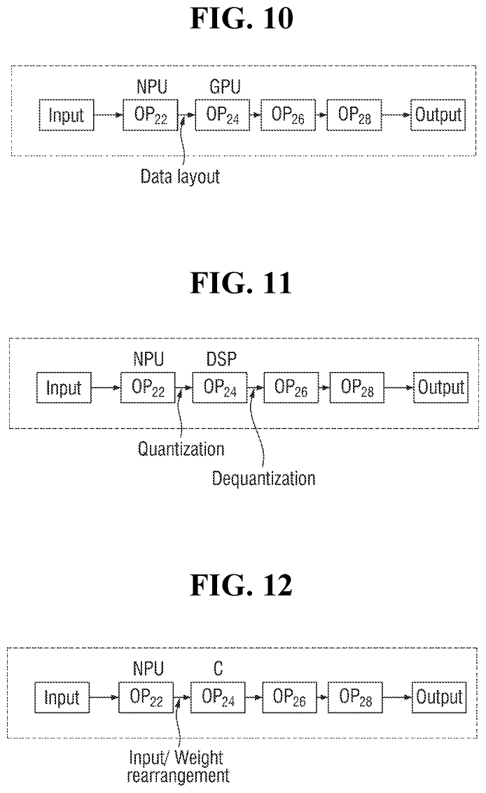

FIG. 10 is a block diagram illustrating a NN computing method according to exemplary embodiments of the present disclosure.

Referring to FIGS. 2 and 10, the hardware latencies of the hardware computing devices 300 may be changed by changing, via the task manager 240, the relationships between heterogenous hardware computing devices 300, and a minimum total hardware latency measurement may be found by adding/modifying pre- or post-processing in accordance with a change in the operation path.

According to the exemplary embodiment of FIG. 10, a GPU may be added to the operation path. In a case in which the GPU is added as a hardware computing device 300, a data layout may be processed first, and an operation of the GPU may be performed.

The data layout is a method of converting data to a particular format, such as the format of an image file, before subjecting the data to computation or storing the data. Examples of the particular format may include NCHW, NHWC, CHWN, nChw8c, and nChw16c.

If the operation of the GPU is the operation OP₂₄, the data layout may be performed, receiving output activation from the operation OP₂₂. As a result, the hardware latency of the GPU can be changed.

FIG. 11 is a block diagram illustrating a NN computing method according to exemplary embodiments of the present disclosure.

Referring to FIGS. 2 and 11, a DSP may be added to the operation path. In a case in which a DSP is added as a hardware computing device 300, quantization may be performed, and then, an operation of the DSP may be performed. Thereafter, dequantization may be performed.

For example, in a case in which a dedicated NPU is operated in units of 32 bits, 8-bit quantization may be performed before the input of an operation of the DSP, and 32-bit dequantization may be performed after the operation of the DSP.

In a case in which an operation OP₂₄ is the operation of the DSP, quantization may be performed after the output of the operation OP₂₂, and dequantization may be performed before the input of an operation OP₂₆.

FIG. 12 is a block diagram illustrating a NN computing method according to exemplary embodiments of the present disclosure.

Referring to FIGS. 2 and 12, an arbitrary hardware computing device C may be installed in the operation path, and an input/weight rearrangement may be performed before an operation of the hardware computing device C.

For example, in a case in which the operation of the hardware computing device C is optimized for matrix multiplication and an operation OP₂₂ is output in the format of Fmap, the operation OP₂₂ may be converted into “Matrix” before the input of the operation of the hardware computing device C. Even in a case in which the same output values are received, an input/weight rearrangement, which is for preparing data in advance in a hardware computing device, may be added.

Referring to FIG. 12, an input/weight rearrangement may be added after the output of the operation OP₂₂.

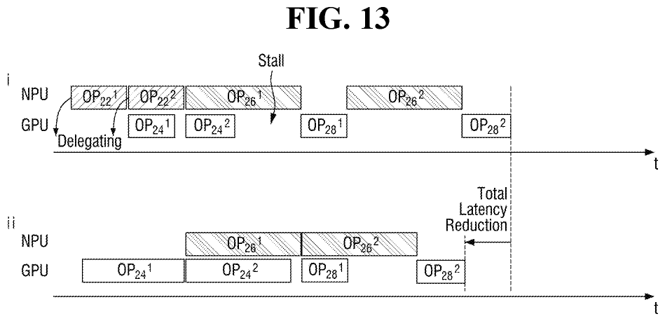

FIG. 13 is a timing diagram illustrating the benefits of the NN computing method according to the exemplary embodiment of FIG. 8.

Referring to FIGS. 8 and 13, operations OP₂₂¹ and OP₂₂² of an NPU may be delegated to a GPU. Accordingly, the operations OP₂₂¹ and OP₂₂² may operate as if they were merged with operations OP₂₄¹ and OP₂₄².

Referring to FIG. 13, operation OP₂₄¹ may begin in the GPU, and then, operation OP₂₄² may begin in the GPU. After the operation OP₂₄², operations OP₂₈¹ and OP₂₈² may begin in the GPU, following the operations OP₂₆¹ and OP₂₆², respectively.

Referring to sections “i” and “ii” of FIG. 13, a total hardware latency in a NN can be reduced by changing the hardware latency of each hardware computing device 300 through the delegation of operations, and as a result, a stall “Stall” can be eliminated. For example, the total hardware latency can be reduced by improving hardware utilization.

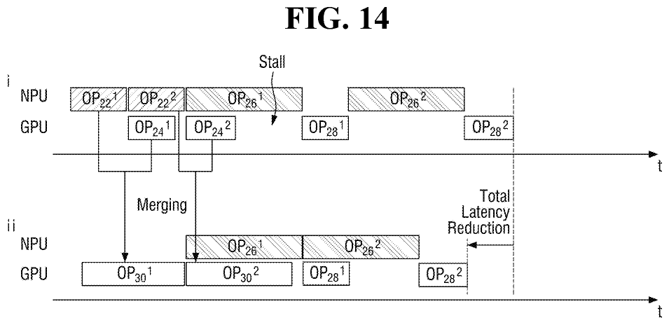

FIG. 14 is a timing diagram illustrating the benefits of the NN computing method according to the exemplary embodiment of FIG. 9.

Referring to FIGS. 9 and 14, operations OP₂₂¹ and OP₂₂² of an NPU may be merged with operations OP₂₄¹ and OP₂₄² of a GPU, thereby creating operations OP₃₀¹ and OP₃₀².

As a result, a stall “Stall” can be eliminated, and a total hardware latency can be reduced.

As is traditional in the field of the present disclosure, exemplary embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Herein, the term “circuit” may refer to an analog circuit or a digital circuit. In the case of a digital circuit, the digital circuit may be hard-wired to perform the corresponding tasks of the circuit, such as a digital processor that executes instructions to perform the corresponding tasks of the circuit. Examples of such a processor include an application-specific integrated circuit (ASIC) and a field-programmable gate array (FPGA).

While the present disclosure has been particularly shown and described with reference to the exemplary embodiments thereof, it will be understood by those of ordinary skill in the art that various changes in form and detail may be made therein without departing from the spirit and scope of the present disclosure as defined by the following claims.

What is claimed is:

1. A neural network computing system, comprising:
a processor; and
a deep learning framework under control of the processor, wherein the deep learning framework is configured to:
obtain model information of a neural network model by reading at least one neural network model file;
create a neural network graph of the neural network model using the model information;
adjust the neural network graph such that the neural network model corresponds to an operation of a first hardware computing device and an operation of a second hardware computing device, which is different from the operation of the first hardware computing device;
divide the neural network model into a plurality of sub-models, including first and second sub-models;
pipeline the first and second hardware computing devices by allocating the first and second sub-models to the first and second hardware computing devices, respectively; and
detect a reduced hardware latency measurement from among a plurality of hardware latency measurements obtained by changing at least one of hardware latencies of the first and second sub-models.

2. The neural network computing system of claim 1, wherein changing the at least one of the hardware latencies of the first and second sub-models comprises replacing, merging, or dividing the first and second sub-models.

3. The neural network computing system of claim 1, wherein changing the at least one of the hardware latencies of the first and second sub-models comprises delegating part of the operation of the first hardware computing device, which has a longest hardware latency, to the second hardware computing device.

4. The neural network computing system of claim 1, wherein changing the at least one of the hardware latencies of the first and second sub-models comprises replacing, merging, or dividing the operations of the first and second hardware computing devices.

5. The neural network computing system of claim 1, wherein changing the at least one of the hardware latencies of the first and second sub-models comprises changing an output, frequency, or mode of the first or second hardware computing device.

6. The neural network computing system of claim 1, wherein changing the at least one of the hardware latencies of the first and second sub-models comprises changing a hardware capability of the first or second hardware computing device.

7. A neural network computing method, comprising:
obtaining model information of a neural network model by reading at least one neural network model file;
creating a neural network graph of the neural network model using the model information;
dividing the neural network model into a plurality of sub-models, including first and second sub-models;
pipelining first and second hardware computing devices by allocating the first and second sub-models to the first and second hardware computing devices, respectively,
wherein the second hardware computing device performs a different operation from the first hardware computing device; and
compiling the first and second sub-models into the first and second hardware computing devices, respectively.

8. The neural network computing method of claim 7, further comprising:
detecting a reduced hardware latency from among a plurality of hardware latency measurements obtained by changing at least one of hardware latencies of the first and second sub-models.

9. The neural network computing method of claim 8, wherein changing the at least one of the hardware latencies of the first and second sub-models comprises delegating part of an operation of the first hardware computing device, which has a longest hardware latency, to the second hardware computing device.

10. The neural network computing method of claim 8, wherein changing the at least one of the hardware latencies of the first and second sub-models comprises replacing, merging, or dividing the first and second sub-models.

11. The neural network computing method of claim 7, wherein the first and second hardware computing devices are pipelined based on parameters defined in each of the neural network model files.

12. The neural network computing method of claim 7, further comprising:
measuring a total hardware latency by changing the first and second hardware computing devices in accordance with a dynamic hardware schedule; and
determining a reduced total hardware latency measurement.

13. The neural network computing method of claim 7, further comprising:
measuring a total hardware latency by adding/modifying pre- or post-processing in accordance with a change in an operation path; and
determining a reduced total hardware latency measurement.

14. The neural network computing method of claim 13, further comprising:
when a digital signal processor is included in the operation path, performing quantization before an operation of the digital signal processor or performing dequantization after the operation of the digital signal processor.

15. The neural network computing method of claim 13, further comprising:
when a graphics processing unit is included in the operation path, adding a data layout before an operation of the graphics processing unit.

16. The neural network computing method of claim 13, further comprising:
when the first hardware computing device is included in the operation path, adding an input/weight rearrangement before an operation of the first hardware computing device.

17. A computer system, comprising:
a processor controlling a total operation of the computer system;
a memory storing data for controlling the computer system;
a deep learning framework controlled by the processor; and
a plurality of hardware computing devices controlled by the deep learning framework,
wherein the deep learning framework is configured to:
obtain model information of a neural network model by reading at least one neural network model file;
create a neural network graph of the neural network model using the model information;
adjust the neural network graph such that the neural network model corresponds to an operation of a first hardware computing device and an operation of a second hardware computing device, which is different from the operation of the first hardware computing device;
divide the neural network model into a plurality of sub-models, including first and second sub-models;
pipeline the first and second hardware computing devices by allocating the first and second sub-models to the first and second hardware computing devices, respectively; and
detect a reduced hardware latency measurement from among a plurality of hardware latency measurements obtained by changing at least one of hardware latencies of the first and second sub-models.

18. The computer system of claim 17, wherein changing the at least one of the hardware latencies of the first and second sub-models comprises delegating part of the operation of the first hardware computing device, which has a longest hardware latency, to the second hardware computing device.

19. The computer system of claim 17, wherein changing the at least one of the hardware latencies of the first and second sub-models comprises replacing, merging, or dividing the first and second sub-models.

20. The computing system of claim 17, wherein changing the at least one of the hardware latencies of the first and second sub-models comprises changing an output, frequency, or mode of the first or second hardware computing device.
